(19) United States
(12) Patent Application Publication
(10) Pub. No.: US 2008/0206026 A1
(43) Pub. Date: Aug. 28, 2008

(54) TOOL CARRIER

(76) Inventor: Robert L. JONES, Huron, OH (US)

Correspondence Address: STANDLEY LAW GROUP LLP, 495 METRO PLACE SOUTH, SUITE 210, DUBLIN, OH, 43017, US

(21) Appl. No.: 11/679,833

(22) Filed: Feb. 27, 2007

(51) Int. Cl. B62D 63/02

(52) U.S. Cl. 414/349

(57) ABSTRACT

A tool carrier adapted to provide one or more benefits including, but not limited to, a less obstructed view of tool operation for an operator, improved maneuverability of tools, and the ability to more easily integrate various tool packages with a vehicle. Exemplary embodiments of a tool carrier may comprise one or more of the following features: 1) a tool carriage frame, which may be seen through; 2) a power system support frame; 3) a power supply and means for power transmission (e.g., a hydraulic power supply and means for hydraulic power transmission); 4) a wheel system (e.g., a front paired wheel system and a back paired wheel system); 5) means for controlling motion of a tool carrier; 6) a steering system (e.g., a hydraulically-actuated steering system that steers a front wheel pair simultaneously with and contrarily to a back wheel pair to enhance turning performance); 7) means for quick-disconnecting any connections (e.g., hydraulic connections) between a power system support frame and a tool carriage frame; and 8) an interchangeable frame construction, which may further comprise an easy means for attachment and detachment of a power system support frame and tool carriage frame to and from each other to promote the use of a variety of tool packages.

### BACKGROUND AND SUMMARY OF THE INVENTION

Exemplary embodiments of the present invention are directed to tools (e.g., agricultural tools) and more specifically, to tool carriers. Certain exemplary embodiments of the present invention may be primarily described with respect to self-propelled vehicular tool carriers. Nevertheless, other exemplary embodiments of tool carriers of the present invention may not include any means for imparting motion.

The desire to increase agricultural productivity has for centuries been the focus of farmers. As technology has advanced, the uses of self-propelled vehicles have demonstrated their benefit by providing a means for transporting agricultural tools; the farm tractor is one example. A typical farm tractor has many drawbacks, however. For example, a typical farm tractor provides limited maneuverability and is cumbersome to use. In addition, an operator of a typical farm tractor has limited visibility of associated tools during operation, particularly when such tools are carried behind the tractor. Furthermore, methods to use tool packages with conventional tractors are generally limited, restricted, ineffective, inefficient, and/or cumbersome. As the need increases to more efficiently and effectively cultivate all available surface area of tillable soil, an improved tool carrying vehicle is needed that provides a less obstructed view of tool operation for the operator, provides increased maneuverability for more efficient and effective operation, and/or provides means to more easily use or integrate various tool packages with the vehicle.

Exemplary embodiments of the present invention may overcome some or all of the above drawbacks inherent in the current state of the art by providing a new and useful tool carrying device, which may be self-propelled. Exemplary embodiments of a tool carrier may offer increased versatility and have application in agriculture or other suitable uses, particularly allowing an operator to more efficiently and effectively tend to or make productive use of land or fields through better implementation of tools. Exemplary embodiments of a tool carrier may also offer one or more other benefits including, but not limited to, a less obstructed view of tool operation for an operator, improved maneuverability of tools, and the ability to more easily integrate various tool packages with a vehicle. For example, exemplary embodiments of a tool carrier may comprise one or more of the following features: 1) a tool carriage frame, which may be seen through; 2) a power system support frame; 3) a power supply and means for power transmission (e.g., a hydraulic power supply and means for hydraulic power transmission); 4) a wheel system (e.g., a front paired wheel system and a back paired wheel system); 5) means for controlling motion of a tool carrier; 6) a steering system (e.g., a hydraulically-actuated steering system that steers a front wheel pair simultaneously with and contrarily to a back wheel pair to enhance turning performance); 7) means for quick-disconnecting any connections (e.g., hydraulic connections) between items supported by a power system support frame and items supported by a tool carriage frame; and 8) an interchangeable frame construction, which may comprise an easy means for attachment and detachment of a power system support frame and tool carriage frame to and from each other to promote the use of a variety of tool packages.

In addition to the novel features and advantages mentioned above, other benefits will be readily apparent from the following descriptions of the drawings and exemplary embodiments.

### BRIEF DESCRIPTION OF THE DRAWINGS

FIG. 1 is a first side perspective view of an exemplary embodiment of a tool carrier of the present invention.

FIG. 2 is a second side perspective view of the tool carrier of FIG. 1.

FIG. 3 is a front perspective view of the tool carrier of FIG. 1.

FIG. 4 is a rear perspective view of the tool carrier of FIG. 1.

FIG. 5 is a top perspective view of a portion of the tool carrier of FIG. 1.

FIG. 6 is a top perspective view of a first portion of the tool carrier of FIG. 1 generally from an operator's perspective.

FIG. 7 is a top perspective view of a second portion of the tool carrier of FIG. 1 generally from an operator's perspective.

FIG. 8 is a top perspective view of a third portion of the tool carrier of FIG. 1 generally from an operator's perspective.

### DETAILED DESCRIPTION OF THE EXEMPLARY EMBODIMENT(S)

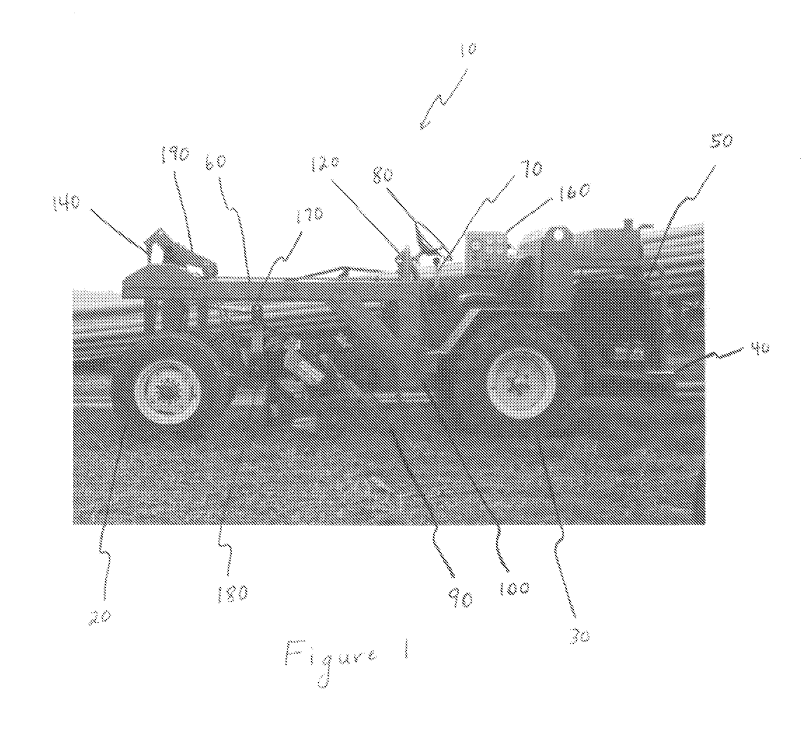

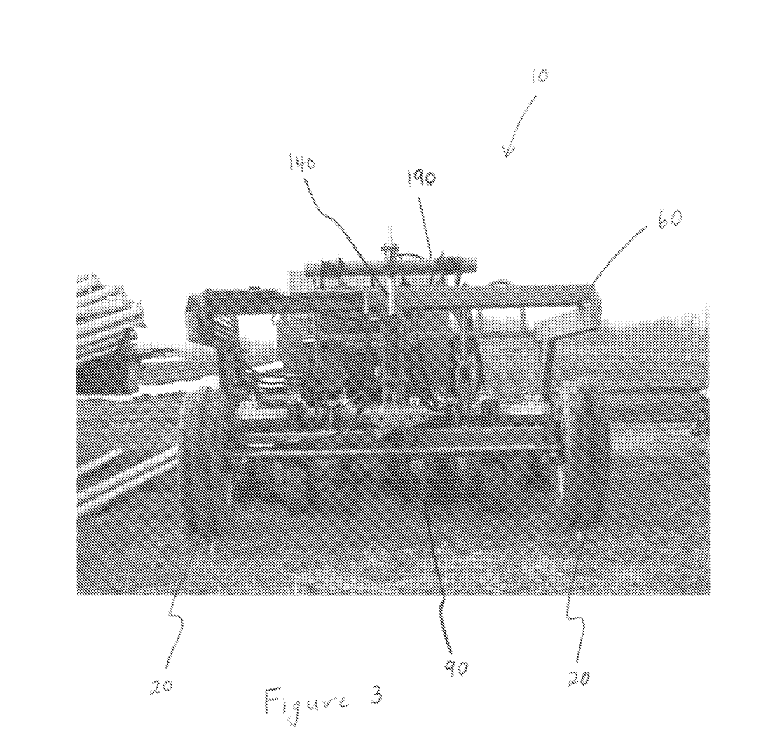

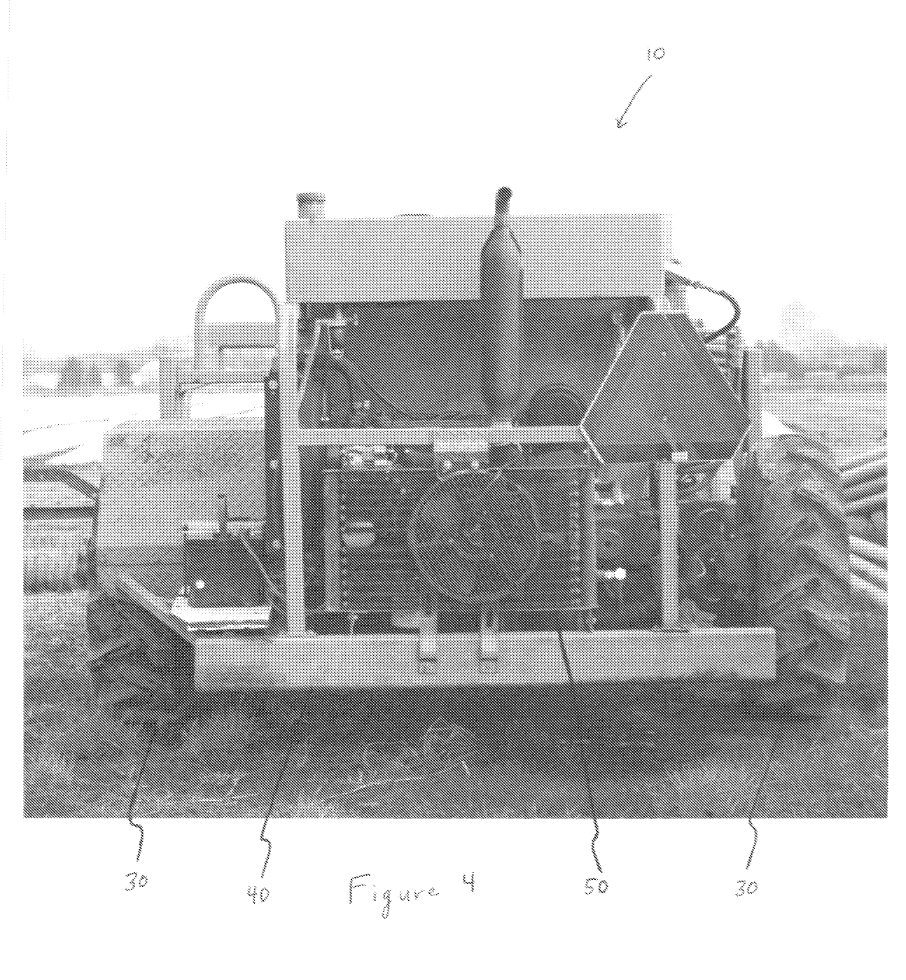

An exemplary embodiment of a tool carrier 10 is shown in FIGS. 1 through 8. Referring now primarily to FIGS. 1 through 5, this example of tool carrier 10 comprises a front paired wheel system 20, a rear paired wheel system 30, a power system support frame 40, a power system 50, a tool carriage frame 60, means for controlling motion 70, and a steering system 80. The tool carriage frame 60 may be adapted to accommodate any number of different tool packages 90, such as, but not limited to, a planter carrier, personnel carrier, transplanter, cultivator, tilling wheels, a blade, a scoop, a bucket, and other similar or suitable tool packages. It should be recognized that other exemplary embodiments of a tool carrier may comprise any suitable combination of the above features.

In this exemplary embodiment, steering of tool carrier 10 may be accomplished by means of operator steering system 80, which is preferably adjustable and adapted to steer the front wheel pair 20 contrarily to and simultaneously in concert with the back wheel pair 30 such as, for example, via means for hydraulic power transmission and conventional hydraulic actuators. This example of a steering arrangement may enhance turning performance in contrast to a less capable conventional front wheel steering scheme only. Moreover, an exemplary embodiment of tool carrier 10 may have a relatively short wheel base, which may further enhance turning performance.

An operator may be seated on a forward portion of the power system support frame 40. In other exemplary embodiments, different seating arrangements are possible. In this exemplary embodiment, power supply system 50 may be a hydraulic power supply system including means for power transmission, which may be primarily supported on power system support frame 40. As one exemplary means to propel the tool carrier 10, hydraulic power may be transmitted via hydraulic pressure hoses to at least one hydraulic motor. For example, hydraulic motors may be respectively attached to the wheels of the rear paired wheel system 30, thereby simplifying power transmission by beneficially eliminating mechanical power transmission through means such as torque tubes and gearing. An alternative embodiment may similarly comprise four hydraulic motors, each respectively attached to respective wheels, to provide an all-wheel drive configuration. Motion control of the tool carrier 10 may be accomplished by means of a hydraulic control valve system operated by an operator via, for example, a lever control 70, which may be used, for example, to control forward and rearward travel direction, speed, and braking. Optionally, selected control features may be divided between control levers, knobs, wheels, foot pedals, and/or other similar or suitable means for providing power and motion control.

The aforementioned wheel configuration, steering arrangement, and power system are particularly useful for facilitating improved maneuverability and steering. Nevertheless, some exemplary embodiments of a tool carrier may include other wheel configurations, steering arrangements, and power supplies. For example, some exemplary embodiments may include a different number and/or arrangement of wheels. For instance, some exemplary embodiments may have fewer than or greater than four wheels (e.g., one front wheel and two back wheels, or vice versa, etc.), and some exemplary embodiments may have different spacing between the wheels. Other steering systems are also possible such as levers, peddles, or other similar or suitable steering mechanisms. Furthermore, some exemplary embodiments of a tool carrier may include other means for providing power. For example, although hydraulic power may offer many advantages such as described herein, some exemplary embodiments of a tool carrier may utilize mechanical or electromechanical motors and power transmissions.

Tool carrier 10 may comprise means to mechanically connect and disconnect tool carriage frame 60 from the power system support frame 40 by means of fasteners, such as bolts, screws, male/female connectors, brackets, clips, or other similar or suitable fasteners, at interconnection points 100 and 110. For example, four bolts 102 may be used at interconnection point 100 to connect power system support frame 40 to tool carriage frame 60. A similar arrangement may be provided at interconnection point 110. In other exemplary embodiments, any suitable number of fasteners may be used. In this exemplary embodiment, connectors may also be provided for connecting and disconnecting power system 50 to and from items associated with tool carriage frame 60. For example, connectors 120 (e.g., quick-disconnect connectors or other similar or suitable connectors) may enable hydraulic communication with steering system 80. In particular, in an exemplary embodiment such as illustrated, steering control system 80 may be mounted on the tool carriage frame 60 with the quick-disconnect connectors 120 positioned between the hydraulic power supply 50 and steering control system 80, thereby promoting the ability to easily detach the tool carriage frame 60 from the power system support frame 40. In another exemplary embodiment, steering control system 80 may be alternatively mounted to the power system support frame 40 with quick-disconnect connectors 120 positioned between the steering control system 80 and the front paired wheel system 20 to similarly provide the ability to easily detach the tool carriage frame 60 from the power system support frame 40. Such an exemplary embodiment may mitigate the need to duplicate a separate steering control system 80 on each of a wide range of tool carriage frames, thereby saving cost. Furthermore, connectors 130 (e.g., quick-disconnect connectors or other similar or suitable connectors) may enable hydraulic communication with front wheel pair 20, tool package 90, hydraulic lift 140 (which may be used in association with tool package 90 to move it into and out of position for operation), and/or any other similar or suitable item that may be associated with tool carriage frame 60. These features advantageously allow the vehicle's power system to be adaptively and interchangeably connected to other tool systems requiring power, thereby making the system versatile and novel. For example, other tool carriage frames may be connected to a power system support frame to facilitate the use of other tool packages. Optionally, in some other exemplary embodiments, other mechanical, electrical, and/or electromechanical means may be used to provide power to any suitable items (e.g., tool packages, wheels, lifts, or other similar or suitable items) associated with the tool carriage frame. For example, electrical connectors may be used to facilitate electrical communication as needed.

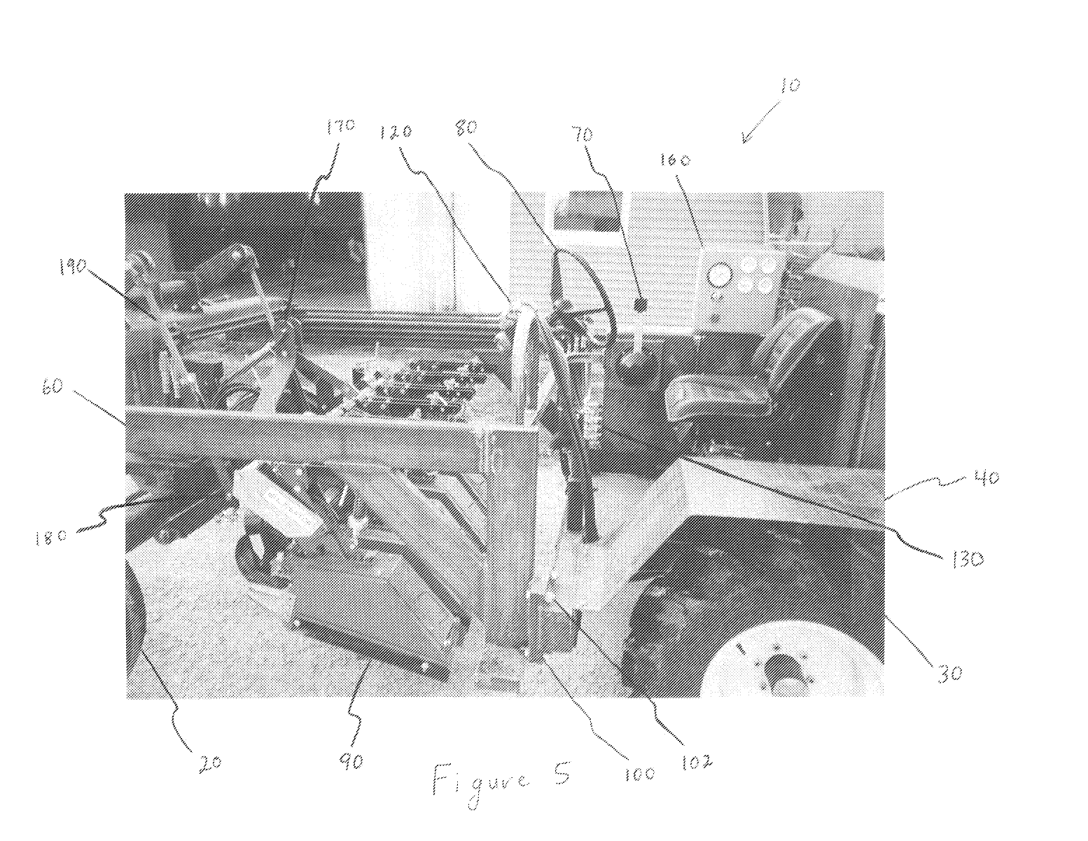

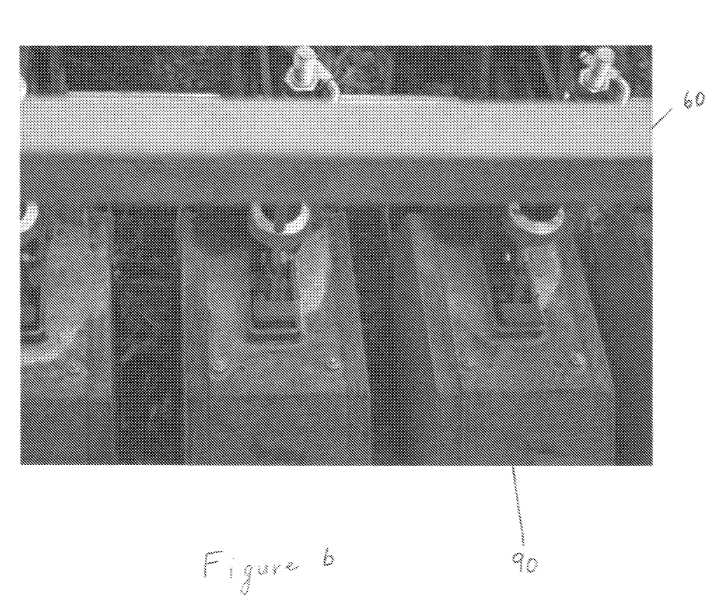

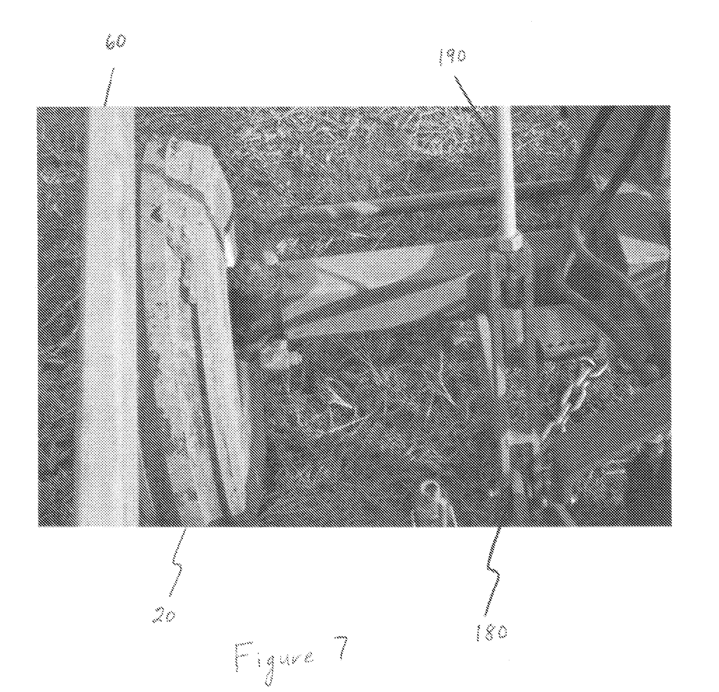

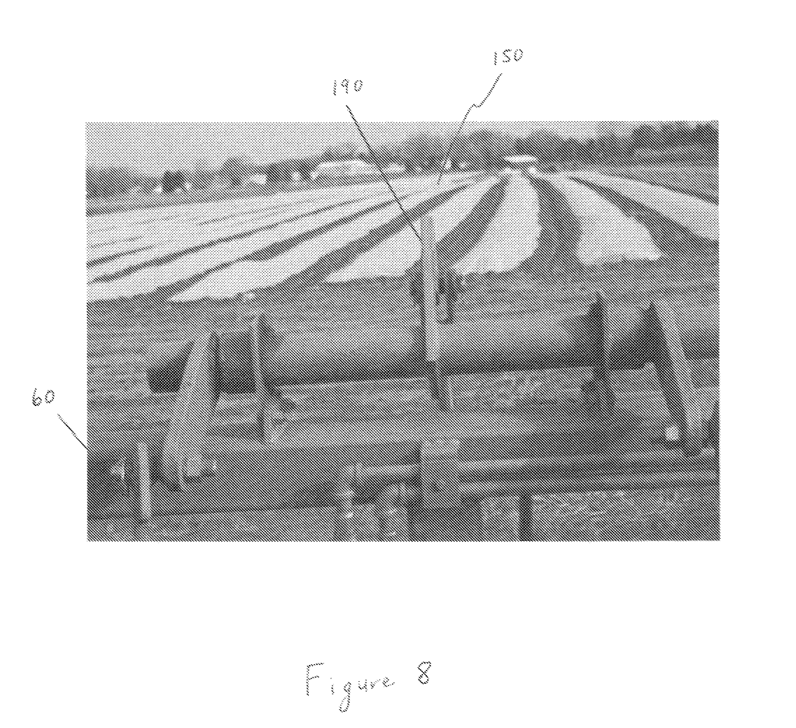

A further feature and significant advantage of this exemplary embodiment of tool carrier 10 lies in the open “see-through” construction of tool carriage frame 60, which provides a clear and relatively unobstructed view of the tool package 90 and its operation from the vantage point of an operator such as is apparent in FIGS. 5 and 6. This exemplary embodiment of tool carriage frame 60 may also enable an improved view of the wheels of front wheel pair 20 such as shown in FIG. 7. This feature allows the operator to more effectively guide tool carrier 10 (such as between crops) and visually monitor tool 90 to promote its more effective implementation as well as to react quickly to negate any unforeseen or undesirable tool activity. Tool carrier 60 may also be configured to enable an operator to have a desirable forward view, such as of crops 150 as shown in FIG. 8. Nevertheless, in some other exemplary embodiments, a tool carriage frame may not offer a see-through construction or enable similar views.

A control panel 160 may provide an operator the ability to monitor system health, such as hydraulic fluid pressure, hydraulic fluid temperature, engine temperature, and fuel supply to name a few. Optionally, a control panel may be provided in association with a tool carriage frame or a power system support frame.

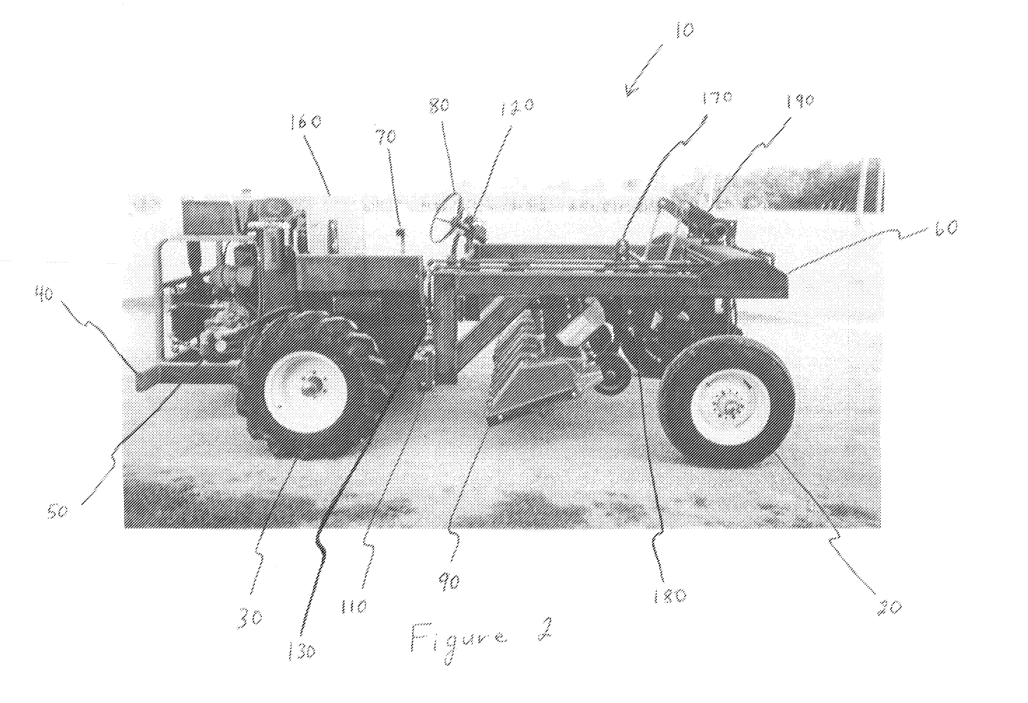

In this exemplary embodiment, tool package 90 is in association with hydraulic lift 140 via linkage 190. In this example, tool package 90 may be connected to linkage 190 at points 170 and 180, such as by hooks, bolts, screws, clips, brackets, male/female connectors, or other similar or suitable fasteners. When lift 140 is elevated in this exemplary embodiment, tool package 90 is lowered into operating position via linkage 190 (see FIG. 1), and tool package 90 is raised out of operating position and into storage or transport position when lift 140 is lowered (see FIG. 2). In this example, linkage 190 is a pivotal, mechanical system. In other exemplary embodiments, any suitable means may be provided for moving a tool package into and out of operating position. It should also be recognized that a tool carriage frame may be adapted to be used with multiple different tool packages. For instance, in this exemplary embodiment, tool package 90 may be disconnected at points 170 and 180 and another suitable tool package may be substituted.

It should also be recognized that the positions of a tool package and any front wheels may be reversed in other exemplary embodiments. For example, a tool package may be positioned on an end portion of a tool carriage system. Such an exemplary embodiment may be useful for front loader applications, blades (such as for moving dirt or snow), seats (such as for personnel carriers), and/or any other similar or suitable applications.

Exemplary embodiments of a versatile tool carrying system may have wide application in agriculture or other suitable applications, particularly on farms with limited or restrictive boundaries, and may allow an operator to more efficiently and effectively make productive use of or tend to land or fields through better implementation of a wide variety of tool packages. Such as described herein, exemplary embodiments of a tool carrier may comprise one or more of the following exemplary features including, but not limited to:
a tool carriage frame, which may be seen through;
a power system support frame;
a power supply and means for power transmission (e.g., a hydraulic power supply and power transmission);
a wheel system (e.g., a front paired wheel system and a back paired wheel system);
means for controlling the motion of the tool carrier;
a steering system, which may be hydraulically actuated, that controls the wheel system (e.g., such that a front wheel pair is steered simultaneously with and contrarily to a back wheel pair to enhance turning performance);
means for connecting and disconnecting (e.g., quick-disconnecting) the connections (e.g., hydraulic connections) between items on a power system support frame and items on a tool carriage frame; and
a novel interchangeable frame construction, which may comprise an easy means for attachment and detachment of a power system support frame and tool carriage frame to and from each other to promote the use of a variety of tool packages.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A tool carrier comprising:
a tool carriage frame;
a power system support frame;
a power supply system supported by said power system support frame;
a wheel system; and
a steering system adapted to control said wheel system;
wherein said power system support frame and said tool carriage frame are adapted to be attached and detached to and from each other.

2. The tool carrier of claim 1 wherein said power supply system is comprised of a hydraulic power supply.

3. The tool carrier of claim 1 further comprising a tool package supported by said tool carriage frame.

4. The tool carrier of claim 3 wherein said tool carriage frame is a see-through frame adapted to enable an operator to see said tool package through said tool carriage frame.

5. The tool carrier of claim 3 wherein said power system support frame and said tool carriage frame are adapted to be attached and detached to and from each other to facilitate the use of a variety of tool packages.

6. The tool carrier of claim 1 wherein said steering system is adapted to be actuated by hydraulic power.

7. The tool carrier of claim 1 wherein said wheel system is adapted to be hydraulically driven.

8. The tool carrier of claim 1 wherein said wheel system is comprised of a front paired wheel system and a back paired wheel system.

9. The tool carrier of claim 8 wherein said front paired wheel system is adapted to be steered contrarily to and simultaneously in concert with said back paired wheel system.

10. The tool carrier of claim 8 wherein said steering system comprises means for quick-disconnection of said steering system from said front paired wheel system.

11. The tool carrier of claim 1 wherein said steering system comprises means for quick-disconnection of said steering system from said power supply system.

12. The tool carrier of claim 1 wherein said tool carrier is adapted to be self-propelled.

13. A tool carrier comprising:
a tool carriage frame;
a power system support frame;
a hydraulic power supply system supported by said power system support frame;
a front paired wheel system and a back paired wheel system; and
a hydraulically-actuated steering system;
wherein said front paired wheel system is adapted to be steered contrarily to and simultaneously in concert with said back paired wheel system.

14. The tool carrier of claim 13 wherein said back paired wheel system is adapted to be hydraulically driven.

15. The tool carrier of claim 13 wherein said steering system comprises means for quick-disconnection of said steering system from said hydraulic power supply system.

16. The tool carrier of claim 13 further comprising means for attachment and detachment of said power system support frame and tool carriage frame to and from each other.

17. The tool carrier of claim 13 further comprising a tool package supported by said tool carriage frame.

18. The tool carrier of claim 17 wherein said tool carriage frame is a see-through frame adapted to enable an operator to see said tool package through said tool carriage frame.

19. A tool carrier comprising:
a tool carriage frame;
a tool package supported by said tool carriage frame;
a power system support frame;
a hydraulic power supply system supported by said power system support frame;
a wheel system comprising a front paired wheel system and a back paired wheel system, said wheel system adapted to be hydraulically driven; and
a hydraulically-actuated steering system;
wherein said tool carriage frame is a see-through frame adapted to enable an operator to see said tool package through said tool carriage frame;
wherein said power system support frame and said tool carriage frame are adapted to be attached and detached to and from each other; and
wherein said front paired wheel system is adapted to be steered contrarily to and simultaneously in concert with said back paired wheel system.

20. The tool carrier of claim 19 wherein said steering system comprises means for quick-disconnection of said steering system from said hydraulic power supply system.
